(19) United States
(12) Patent Application Publication
(10) Pub. No.: US 2016/0140662 A1
(43) Pub. Date: May 19, 2016

(54) FINANCIAL PLANNING TOOL

(71) Applicant: Stephen P. Feehan, Windsor, NY (US)

(72) Inventor: Stephen P. Feehan, Windsor, NY (US)

(21) Appl. No.: 14/828,922

(22) Filed: Aug. 18, 2015

Related U.S. Application Data
(60) Provisional application No. 62/038,496, filed on Aug. 18, 2014.

(51) Int. Cl. G06Q 40/06; G06Q 50/18; G06Q 40/00

(52) U.S. Cl. CPC G06Q 40/06; G06Q 40/10; G06Q 50/186

(57) ABSTRACT

An interactive graphical system is disclosed for ascertaining a person's or business owner's financial status to aid in financial planning. A display graphically and interactively displays the size of a person's or business owner's assets and locations thereof in real time, the assets comprise at least one of the group: investments, Roth funds, 401k/IRA funds, deferred annuities, non-cash assets, life insurance, disability insurance, and cash reserves. Current strategies in place to meet future goals are evaluated and a processor is provided for calculating surplus or deficit cash flow position due to living expenses, current strategies, and taxes in order to formulate strategies for future goals. Tax implications of current asset locations are also considered as part of the planning process. The result of using this inventive tool is to provide clarity of a person's assets and plans.

### RELATED PATENT APPLICATION

The present application is related to U.S. provisional patent application No. 62/038,496, filed Aug. 18, 2014 for FINANCIAL PLANNING TOOL and claims the priority date thereof.

### FIELD OF THE INVENTION

This invention relates to a tool for financial planning and, more particularly, to a tool for ascertaining and displaying a person's or business owner's financial status in real time to aid in financial planning and for calculating surplus or deficit due to living expenses, current strategies, and taxes in order to formulate a strategy of future goals.

### BACKGROUND OF THE INVENTION

Individuals and business owners are often at a loss to understand the value of their own financial assets. In addition to present-day complex financial holdings, individuals can overlook certain assets, especially those that may be longer-term investments. Moreover, statements received from financial institutions, including stock brokerages and banks, are most often presented in table format and not integrated into a comprehensive, simple format.

Even financial planners can find rows of numbers less than clear indications of the positions of their clients' holdings. Planners and clients alike most often describe themselves as “visual” people and understand more clearly when presented information in the form of a picture.

Although straightforward questions should be answered as part of a financial planning process, such questions are simply not considered by many in the course of conducting their business and financial affairs. Analyzing these types of questions and answers helps provide quick insights into a person's structural problems or opportunities in their current planning. These questions include:
a) What assets do I have?
b) What current strategies am I performing or not performing to accumulate or conserve my assets?
c) Am I spending too much or too little?
d) Do I have an intentional strategy to spend, save, invest, or protect every dollar that my business or I accumulate?

It is therefore an object of the invention to provide a system for offering clarity to an individual or a business owner over his or her current financial status.

It is a further object of the present invention to provide a system for graphically displaying a person's or business owner's position of all financial and other assets.

It is yet another object of the present invention to provide a system that displays assets and locations thereof interactively.

It is a further object of the present invention to provide a system that displays financial status in real time.

It is yet another object of the invention to present and analyze questions and answers to help provide insights into a person's structural problems or opportunities in their current planning.

It is yet another object of the present invention to provide a system that calculates surplus or deficit cash flow position to formulate strategies for future goals.

### SUMMARY OF THE INVENTION

In accordance with the present invention, there is provided an interactive system for ascertaining a person's or business owner's financial status to aid in financial planning. A display graphically and interactively displays the size of a person's or business owner's assets and locations thereof, the assets comprising one or more of the group: investments, Roth funds, 401k/IRA funds, deferred annuities, non-cash assets, life insurance, disability insurance, and cash reserves. Current strategies in place to meet future goals are quantified and a processor is provided for calculating surplus or deficit cash flow position due to living expenses, current strategies, and taxes in order to formulate strategies for future goals. Tax implications of current asset locations are also considered as part of the planning process. The result of using this inventive tool is to provide clarity of a person's assets and plans.

The foregoing and other objects and advantages of the present invention are more readily apparent with reference to the following detailed description and the accompanying drawings.

### BRIEF DESCRIPTION OF THE DRAWINGS

A complete understanding of the present invention may be obtained by reference to the accompanying drawings, when considered in conjunction with the subsequent detailed description, in which:

FIG. 1 is a graphical display of an individual's financial status in accordance with the present invention;

FIGS. 2-11 are graphical displays showing successive phases or the build logic of the display of FIG. 1. Specifically, these figures illustrate the following:

FIG. 2 is a graphical display of a portion of the display of FIG. 1 isolating earned income;

FIG. 3 is a graphical display of a portion of the display of FIG. 1 isolating gross income as a function of earned income and business value;

FIG. 4 is a graphical display of a portion of the display of FIG. 1 isolating gross income and cash reserve;

FIG. 5 is a graphical display of a portion of the display of FIG. 1 isolating gross income, cash reserve, and contributors to the cash reserve;

FIG. 6 is a graphical display of a portion of the display of FIG. 1 isolating gross income, cash reserve, contributors to the cash reserve, other assets, and insurance policies;

FIG. 7 is a graphical display of the display of FIG. 6 further including a client name block and assets, liabilities, and net worth totals;

FIG. 8 is a graphical display of the display of FIG. 7 further including a section for displaying living expenses;

FIG. 9 is a graphical display of the display of FIG. 8 further including annuities, social security payments, and pension funds;

FIG. 10 is a graphical display of the display of FIG. 9 further including a section for calculating legacy values; and

FIG. 11 is a graphical display of the display of FIG. 10 further including a section for calculating estate taxes;

FIG. 12 is a graphical display of a business owner's financial status; and

FIG. 13 is a graphical display of an individual's financial status of FIG. 1 further displaying formulas in specified fields to indicate how a processor calculates at least one strategy of future goals as a function of living expenses, current strategies, and taxes.

Like reference numerals refer to like parts throughout the several views of the drawings.

### DETAILED DESCRIPTION OF THE PREFERRED EMBODIMENT

Although the following detailed description contains specific details for the purposes of illustration, those of ordinary skill in the art will appreciate that variations and alterations to the following details are within the scope of the invention. Accordingly, the exemplary embodiments of the invention described below are set forth without any loss of generality to, and without imposing limitations upon, the claimed invention.

An interactive system is provided for ascertaining a person's or business owner's financial status to aid in financial planning. A display graphically and interactively displays the size of a person's or business owner's assets and locations thereof in real time. A processor is provided for calculating surplus or deficit due to living expenses, current strategies, and taxes in order to formulate strategies for future goals.

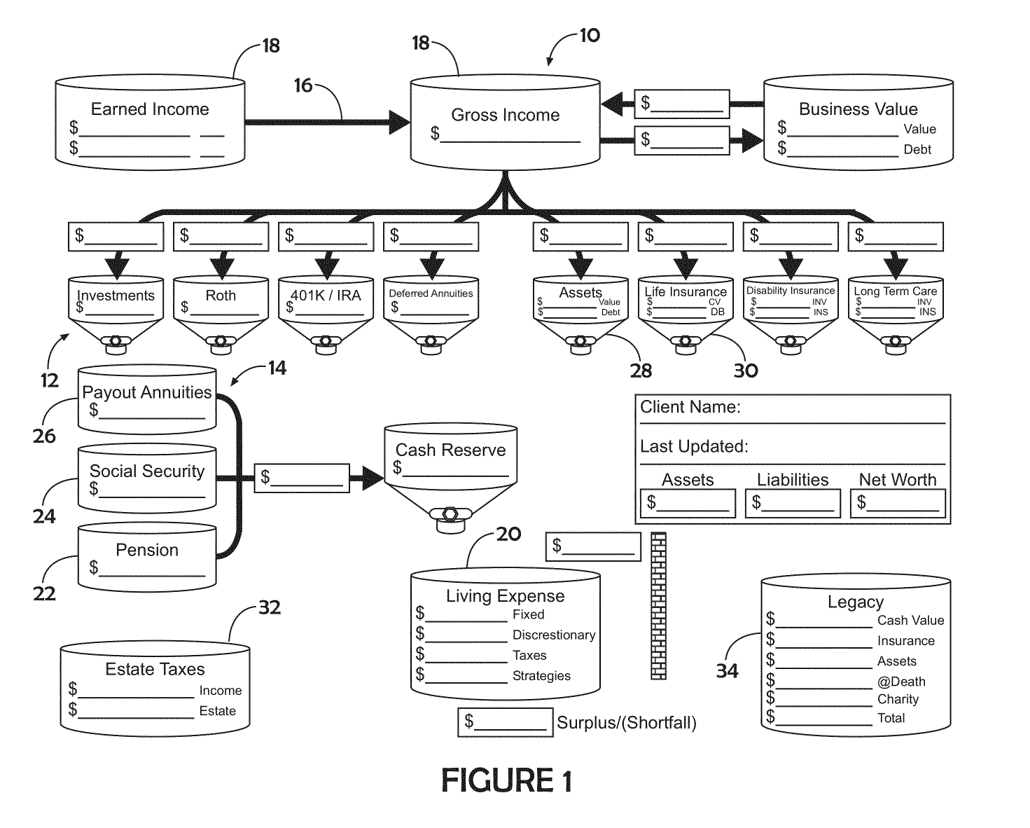

Referring now to FIG. 1, there is shown a graphical display 10 of an individual's financial status in accordance with the present invention. A series of funnels 12, pucks 14, and arrows 16 show the relationship of this financial information so the viewer understands three main and critical pieces of his or her financial picture:
1. The current income 18 and expense 20 of the family represented and, importantly, what amount of income is being applied to strategies for the future, taxes, and whether a surplus or deficit exists each year. Clients in their retirement years also see their pension 22, social security 24 and payout annuities 26.
2. The current assets 28 and liabilities they have and resulting net worth. These assets are organized in funnels that have specific tax treatments unique to each asset type. They will also understand their personal insurance program 30.
3. The resulting taxes 32 and legacy 34 they leave behind at their death.

It should be understood that the shape of pucks and funnels are arbitrary, providing a symbolic representation of quantities and relationships among the elements of the invention. However, any reasonable shapes can be used for the inventive purposes and are considered within the scope of the present invention. The words “puck” and “funnel” herein, therefore, are meant to describe any such alternative shapes.

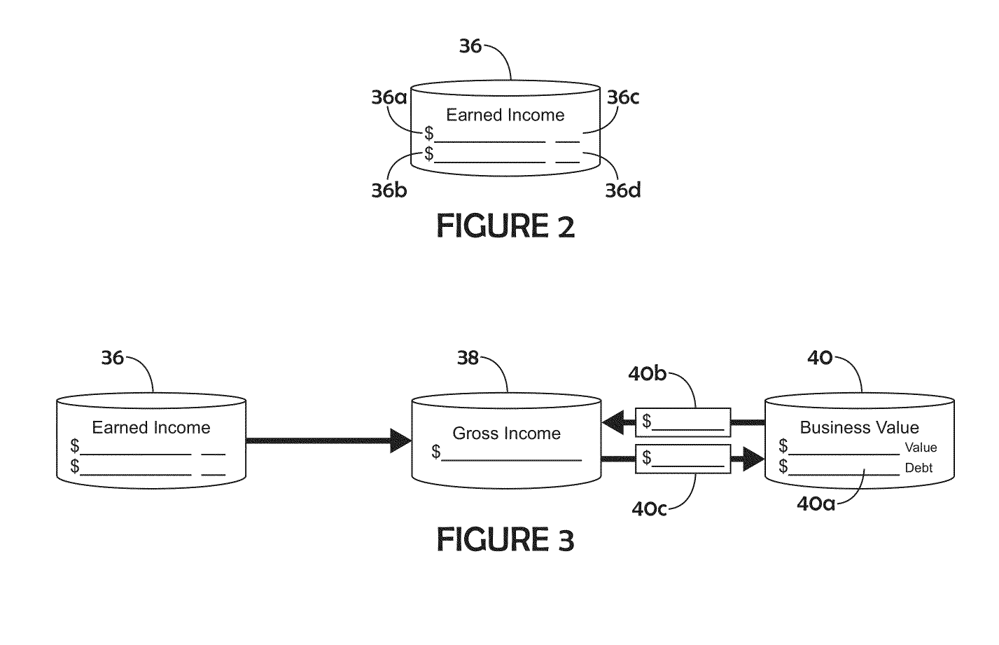

Referring now to FIG. 2, there is shown a graphical display of a portion of the display of FIG. 1 isolating earned income. A puck titled Earned Income 36 has two spots 36a, 36b in the preferred embodiment to show the gross income of two people earning income and two spots 36c, 36d to indicate how much of that income is protected by group disability at work. Of course, the fields can be expanded to include more than two wage earners, if necessary. This FIG. 2 can also be used to separately indicate salary and bonus for a single individual.

Referring now to FIG. 3, there is shown a graphical display of a portion of the display of FIG. 1 isolating gross income as a function of earned income and business value. A puck titled Business Value 40 indicates the value of a client's business, the debt against that business 40a and spots 40b, 40c to indicate, respectively, income received from or investments made to that business (or multiple businesses). This FIG. 3 also adds a puck titled Gross Income 38 that calculates all gross income to the client from other entries made on the diagram.

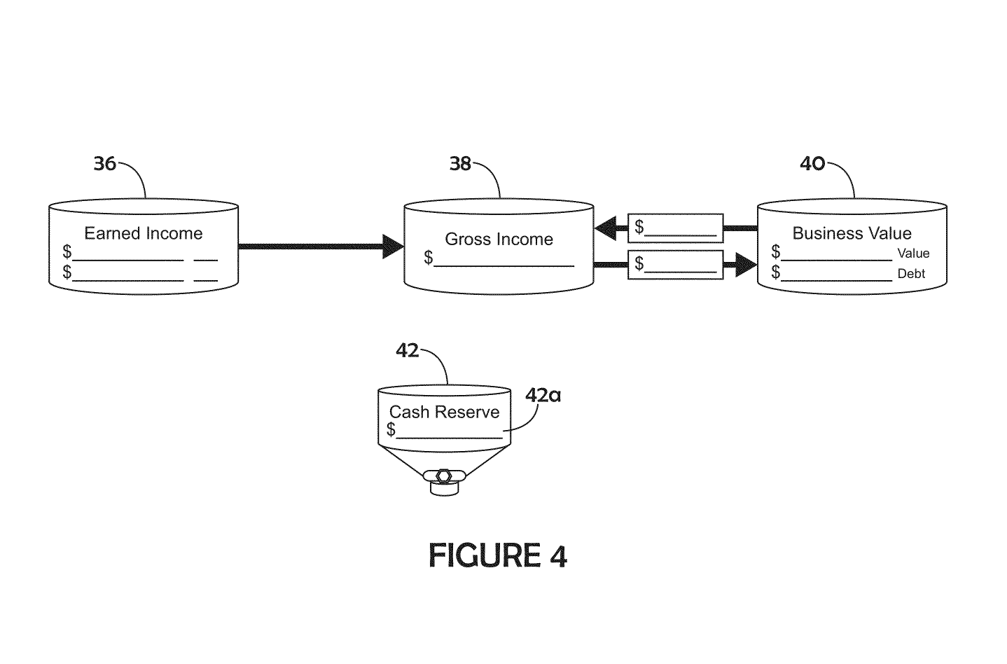

Referring now to FIG. 4, there is shown a graphical display of a portion of the display of FIG. 1 isolating gross income and cash reserve. A puck titled Cash Reserve 42 has a field 42a to enter the client's cash holdings. It also indicates the flow of money from the Gross Income puck 38. It is important to make this relationship clear and also to begin to build the client balance sheet.

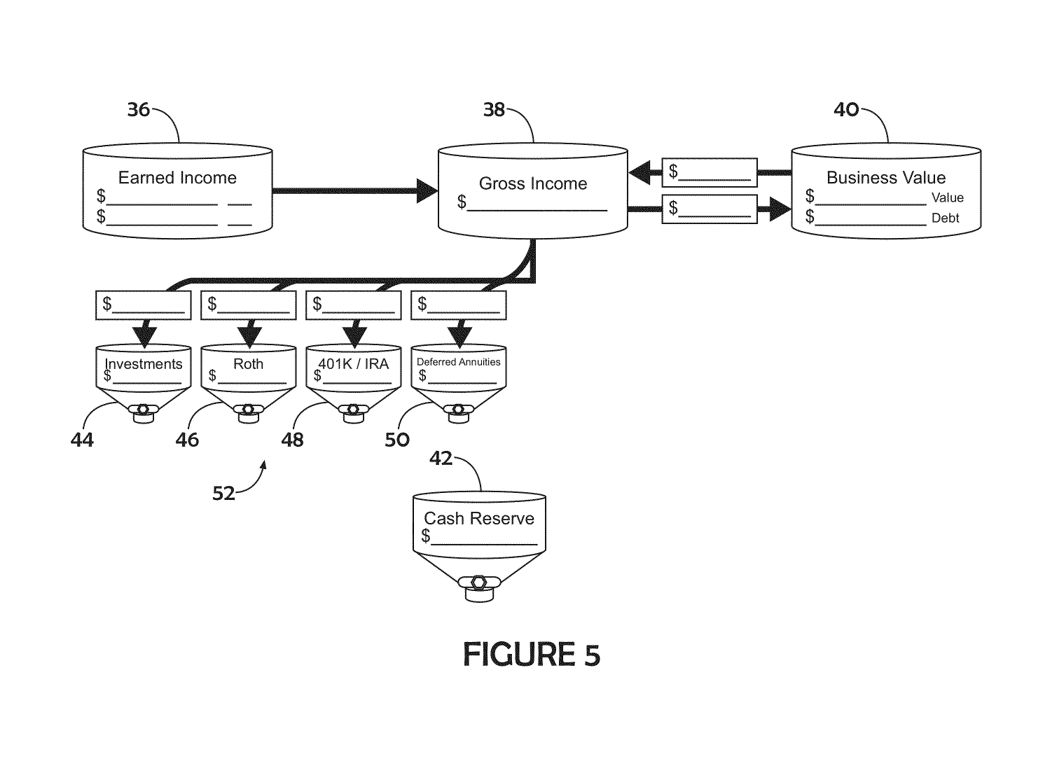

Referring now to FIG. 5, there is shown a graphical display of a portion of the display of FIG. 1 isolating gross income, cash reserve, and contributors to the cash reserve. Four key funnels indicate money being put into four distinct funnels titled: Investment Accounts 44, Roth Accounts 46, 401k/IRA Accounts 48, and Deferred Annuities 50. This allows one to illustrate to the client how much of their assets are in each of these funnels and how much of their income is being deposited into these funnels. The arrows 52 also indicate the flow of money into and out of these funnels to help the client understand where his or her gross income 38 is going and where and how cash reserves 42 are being added to. It should be understood that future investment products and tax-free or tax-deferred vehicles may become available, so the four funnels 44-50 shown in this FIG. 5 are not limiting and may be expanded, still within the scope of the present invention.

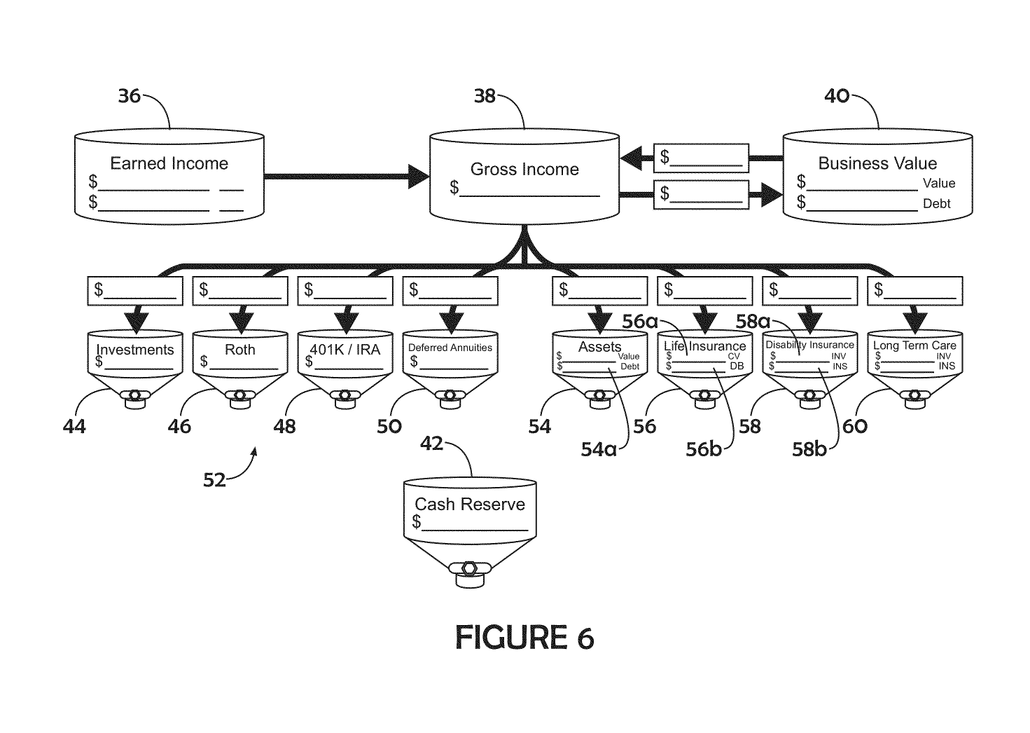

Referring now to FIG. 6, there is shown is a graphical display of a portion of the display of FIG. 1 isolating gross income, cash reserve, contributors to the cash reserve, other assets, and insurance policies. Additional key funnels, indicating money distribution, are titled: Assets 54, Life Insurance 56, Disability Insurance 58, and Long Term Care 60. This illustrates to the client how much of his or her assets are in each of these funnels and how much gross income is being deposited thereinto. The assets funnel 54 also includes a spot 54a for debt that the client holds. The insurance funnels 56, 58 indicate cash value 56a, 58a and death benefit 56b, 58b, respectively, for life insurance, investments dedicated to disability, or long term care events, or insurances associated with disability or long term care. The arrows 52 also indicate the flow of money into and out of these funnels to help the client understand where gross income is going and where and how reserves are being added to.

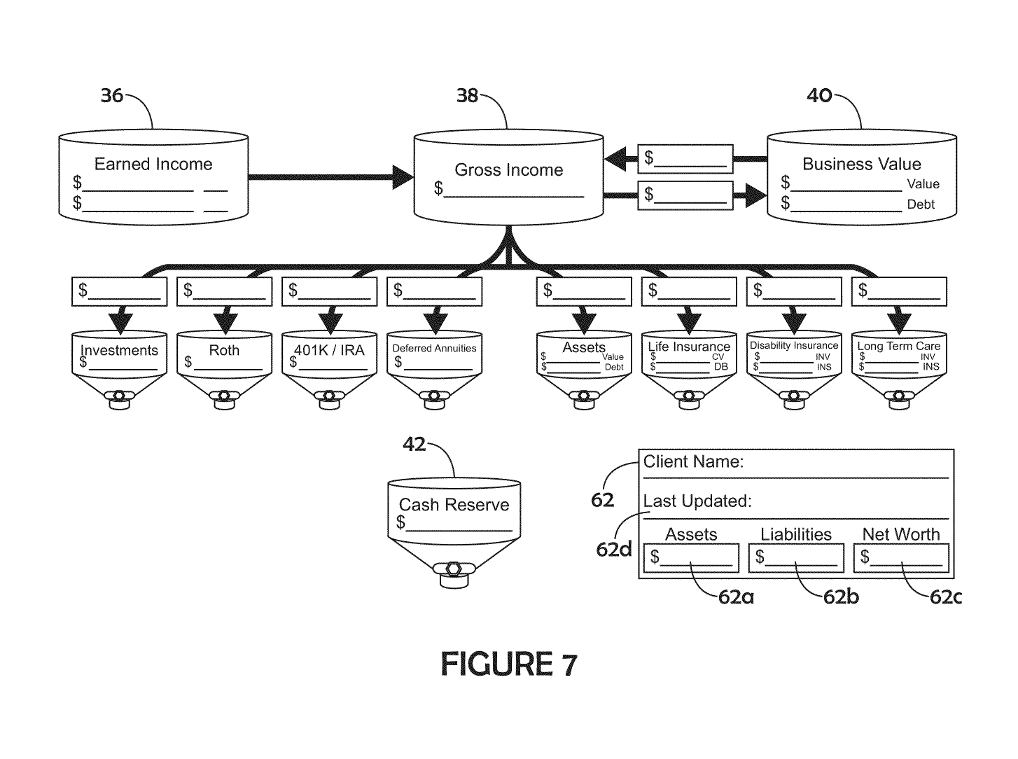

Referring now to FIG. 7, there is shown a graphical display of the display of FIG. 6 further including a client name block 62 and assets 62a, liabilities 62b, and net worth 62c totals. These values are calculated from all of the entries made in previous figures and the quantities entered on this page. Client name block 62 also includes last updated date 62d.

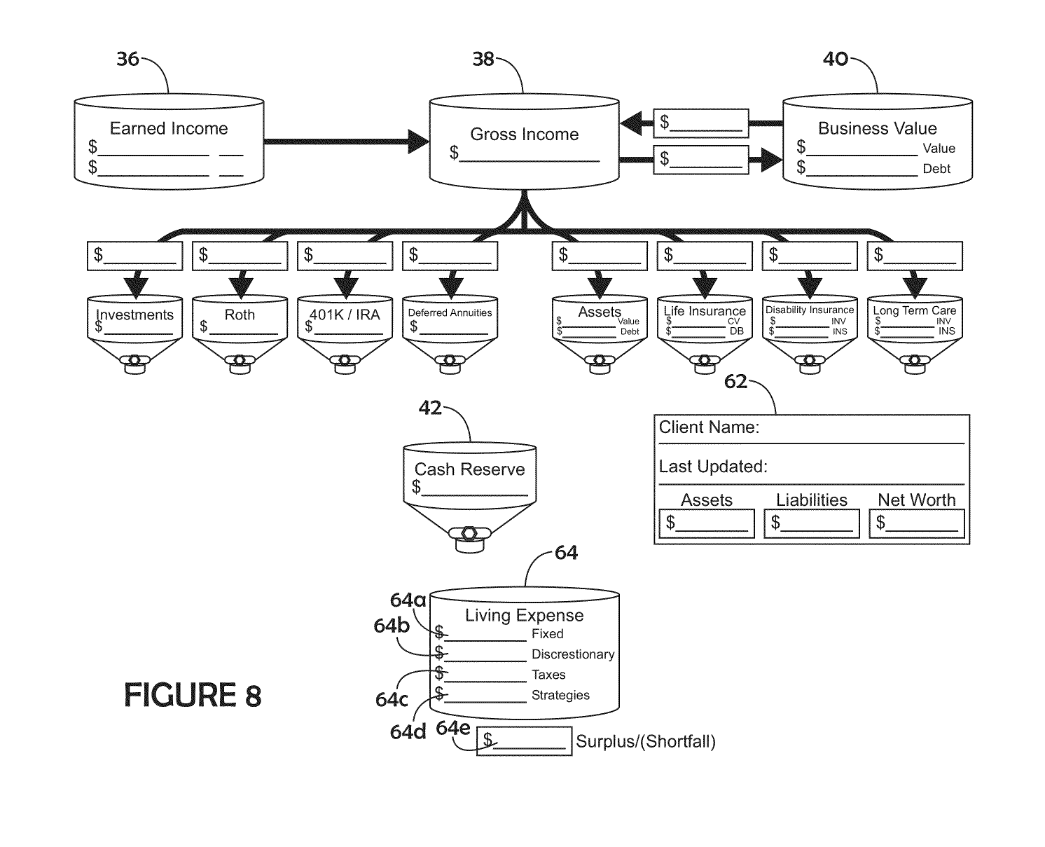

Referring now to FIG. 8, there is shown a graphical display of the display of FIG. 7 further including a section for displaying living expenses. A puck titled Living Expense 64 has fields to enter fixed expenses 64a, discretionary expenses 64b, and taxes 64c. These fields are all entered by the user. It also has the calculated fields for strategies and surplus/(shortfall). The strategies field 64d is the sum total of all of the purposeful and strategic expenditures the client is making. The surplus/(shortfall) field 64e is the calculations of gross income, minus fixed expenses, discretionary expenses, taxes and strategies.

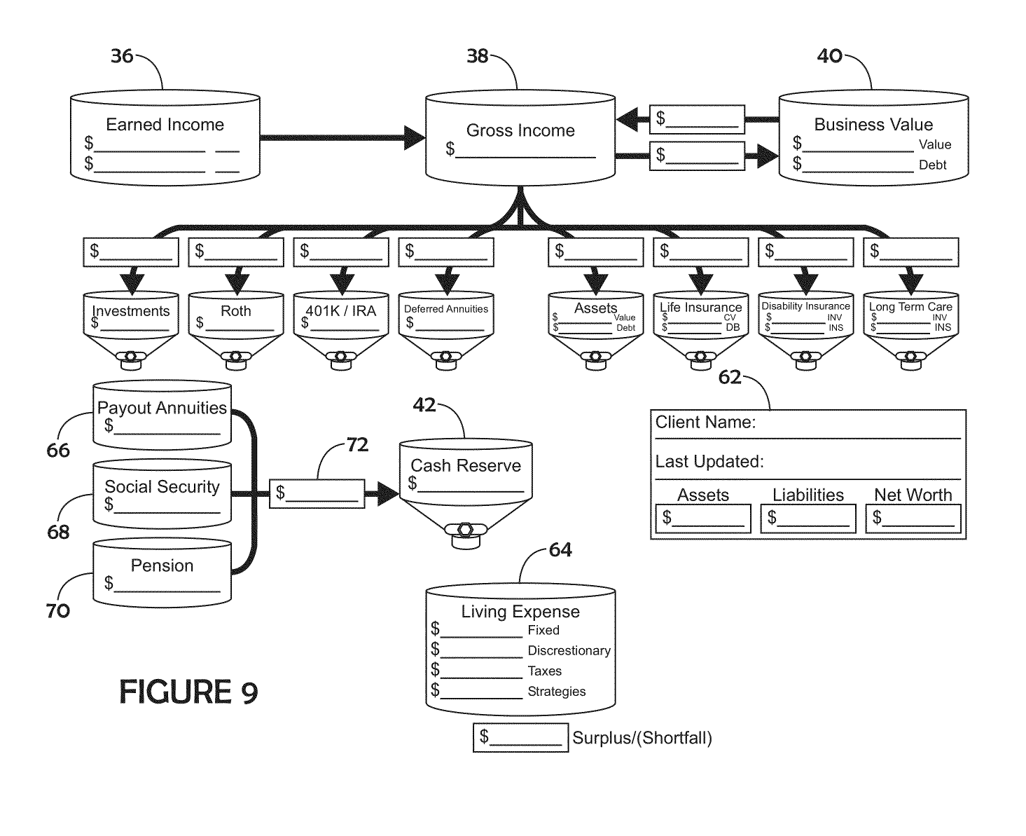

Referring now to FIG. 9, there is shown a graphical display of the display of FIG. 8 further including annuities, social security payments, and pension funds. Three pucks are titled: Payout Annuities 66, Social Security 68, and Pension 70. It also adds a calculated total field 72 with arrows that indicate this income goes into the cash reserve 42. These fields are also added to gross income 38 when numbers are entered.

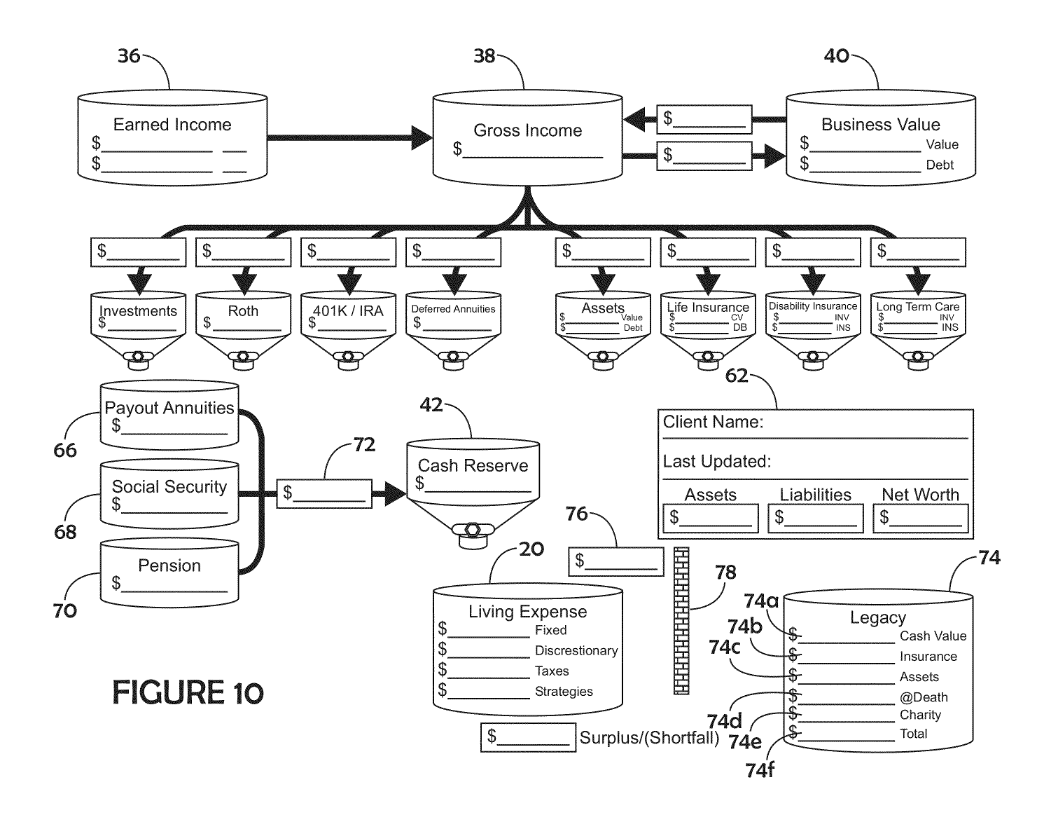

Referring now to FIG. 10, there is shown a graphical display of the display of FIG. 9 further including a section for calculating legacy values. A puck titled Legacy 74 with fields to enter cash value 74a, insurance 74b, assets 74c, @death 74d, and charity 74e. These first three numbers 74a, 74b, 74c indicate assets and insurance transferred during life. The second two numbers 74d, 74e are assets transferred at death. A calculated total field 74f adds insurance, assets, @death and charity to indicate the total legacy the client has left during life and death. This FIG. 10 also has a field 76 to indicate how much money is going into the legacy puck 74 each year. A representation of a “wall” 78 and arrow line 80 that curves over the wall 78 indicates that when the client makes this gift, it is out of the estate.

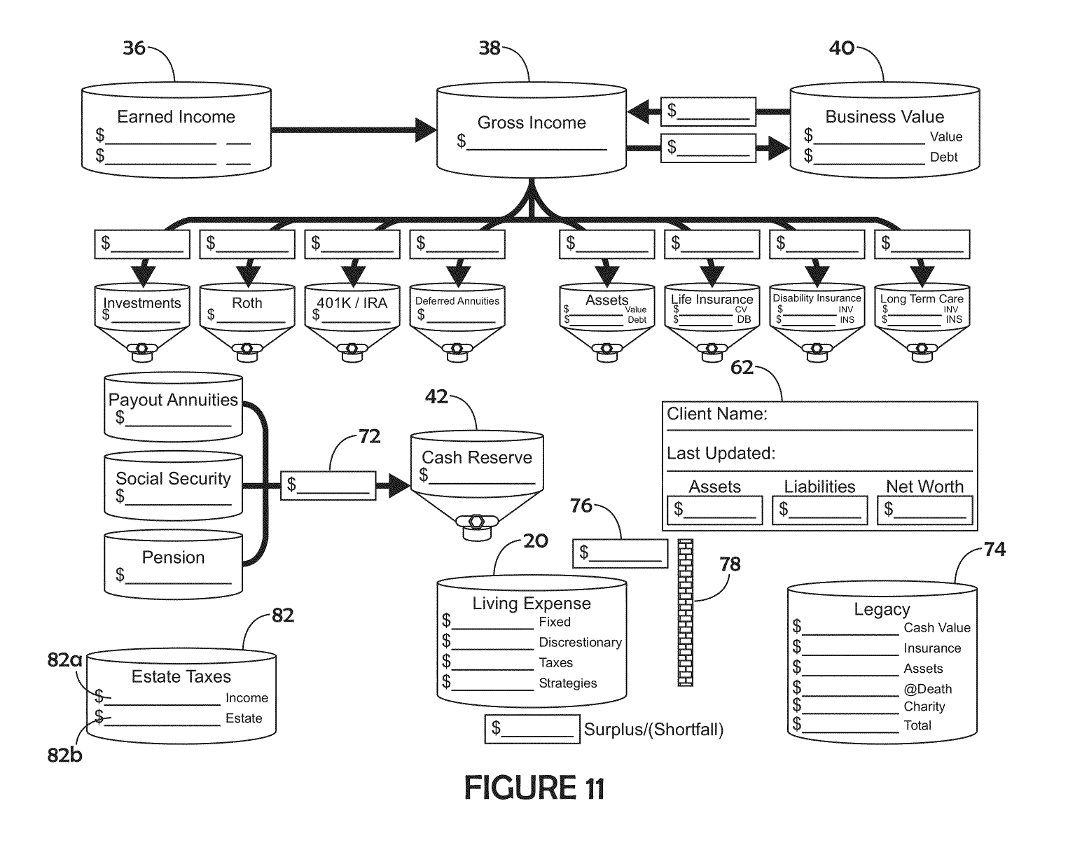

Referring now to FIG. 11, there is shown a graphical display of the display of FIG. 10 further including a section for calculating estate taxes. A puck titled Estate Taxes 82 includes two fields 82a, 82b for income and estate taxes to be entered. A dotted line 84 indicates this flow of money to taxes happens only at death.

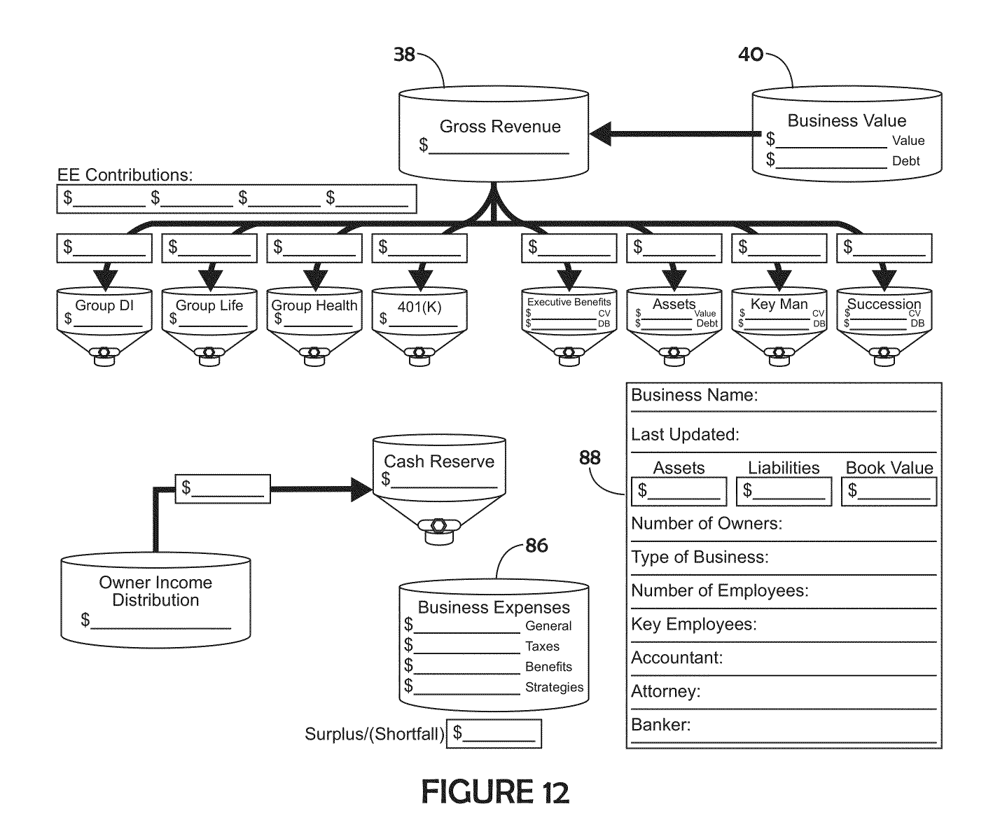

Referring now to FIG. 12, there is shown a graphical display of a business owner's financial status. A complete array of pucks and funnels is provided to enter appropriate numbers for any business 86 that might be owned by a client. It is similar in many respects to FIG. 1, which is for an individual or family. This figure also allows the user to add key information 88 regarding the business (e.g., owners, type of business, number of employees, key employees, accountant, attorney, and banker).

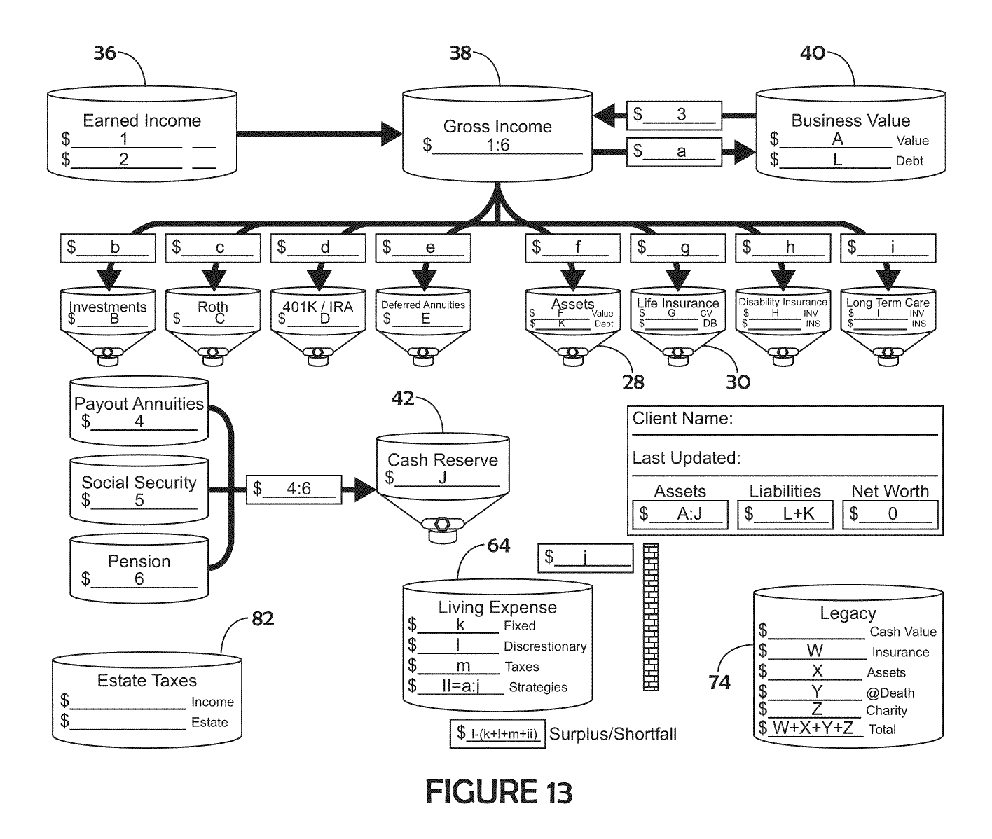

Referring now to FIG. 13, there is shown a graphical display of an individual's financial status of FIG. 1 further displaying formulas in specified fields to indicate how a processor, not shown, calculates at least one strategy of future goals as a function of living expenses, current strategies, and taxes. Although a processor is preferred to perform the foregoing calculations, the inventive system can be implemented with a calculator or even manually. FIG. 13 is the formula key for FIGS. 1-11. Letter values are assigned to each of the fields and the calculation of those letters appears in the calculated fields.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Having thus described the invention, what is desired to be protected by Letters Patent is presented in the subsequently appended claims.

What is claimed is:

1. An interactive graphical system for ascertaining a person's or business owner's financial status to aid in financial planning, comprising:
a) means for graphically and interactively displaying the size of a person's or business owner's assets and locations thereof in real time; and
b) means for calculating surplus or deficit cash flow due to living expenses, current strategies, and taxes in order to formulate strategies for future goals.

2. The interactive graphical system for ascertaining a person's or business owner's financial status to aid in financial planning in accordance with claim 1, wherein said means for calculating surplus or deficit cash flow comprises a processor.

3. The interactive graphical system for ascertaining a person's or business owner's financial status to aid in financial planning in accordance with claim 1, wherein said means for graphically and interactively displaying the size of said person's or business owner's assets comprises pucks representing earned income and gross income.

4. The interactive graphical system for ascertaining a person's or business owner's financial status to aid in financial planning in accordance with claim 3, wherein said means for graphically and interactively displaying the size of a person's or business owner's assets further comprises a funnel representing a cash reserve.

5. The interactive graphical system for ascertaining a person's or business owner's financial status to aid in financial planning in accordance with claim 4, wherein said puck representing earned income comprises space for representing gross income of at least two people.

6. The interactive graphical system for ascertaining a person's or business owner's financial status to aid in financial planning in accordance with claim 1, said person's assets comprising at least one of the group: investments, Roth funds, 401k/IRA funds, deferred annuities, non-cash assets, life insurance, disability insurance, and cash reserves.

7. The interactive graphical system for ascertaining a person's or business owner's financial status to aid in financial planning in accordance with claim 1, further comprising a display of said person's assets, liabilities, and net worth.

8. The interactive graphical system for ascertaining a person's or business owner's financial status to aid in financial planning in accordance with claim 7, further comprising a display of said person's living expenses comprising at least one of the group: fixed expenses, discretionary expenses, taxes, and strategies.

9. The interactive graphical system for ascertaining a person's or business owner's financial status to aid in financial planning in accordance with claim 8, further comprising a display of said person's calculated surplus or shortfall.

10. The interactive graphical system for ascertaining a person's or business owner's financial status to aid in financial planning in accordance with claim 9, further comprising a display of said person's assets comprising at least one of the group:
payout annuities amount, social security amount, and pension amount.

11. The interactive graphical system for ascertaining a person's or business owner's financial status to aid in financial planning in accordance with claim 4, further comprising a display of said person's legacy comprising at least one of the group: cash value, insurance, and assets.

12. The interactive graphical system for ascertaining a person's or business owner's financial status to aid in financial planning in accordance with claim 11, wherein said display of said person's legacy further comprises at least one of the group: @death and charity.

13. The interactive graphical system for ascertaining a person's or business owner's financial status to aid in financial planning in accordance with claim 12, further comprising a display of said person's estate taxes.

14. The interactive graphical system for ascertaining a person's or business owner's financial status to aid in financial planning in accordance with claim 1, further comprising a display of details regarding a business at least partially owned by said person.

15. A method for ascertaining a person's or business owner's financial status to aid in financial planning, the steps comprising:
a) graphically and interactively displaying the size of a person's or business owner's assets and locations thereof in real time; and
b) calculating surplus or deficit cash flow due to living expenses, current strategies, and taxes in order to formulate strategies for future goals.

16. The method for ascertaining a person's or business owner's financial status to aid in financial planning in accordance with claim 15, wherein said graphically and interactively displaying the size of said person's or business owner's assets is accomplished with pucks representing earned income and gross income.

17. The method for ascertaining a person's or business owner's financial status to aid in financial planning in accordance with claim 15, said person's assets comprising at least one of the group: investments, Roth funds, 401k/IRA funds, deferred annuities, non-cash assets, life insurance, disability insurance, and cash reserves.

18. The method for ascertaining a person's or business owner's financial status to aid in financial planning in accordance with claim 15, the steps further comprising displaying said person's assets, liabilities, and net worth.

19. The method for ascertaining a person's or business owner's financial status to aid in financial planning in accordance with claim 15, the steps further comprising displaying said person's calculated surplus or shortfall.

20. The method for ascertaining a person's or business owner's financial status to aid in financial planning in accordance with claim 15, the steps further comprising displaying said person's legacy comprising at least one of the group: cash value, insurance, assets, @death, and charity.
